(19) United States
(12) Patent Application Publication
(10) Pub. No.: US 2022/0127885 A1
(43) Pub. Date: Apr. 28, 2022

(54) DEVICE FOR HOLDING THE TRUNK LID OF A VEHICLE IN AN OPEN POSITION

(71) Applicant: 9303-0302 Quebec Inc., Magog (CA)

(72) Inventors: David MITCHELL, Fitch Bay (CA); Michael MOLINER, Eastman (CA); Sebastien OUELLET, Sherbrooke (CA)

(21) Appl. No.: 17/364,486

(22) Filed: Jun. 30, 2021

Related U.S. Application Data
(63) Continuation of application No. 15/529,746, filed on May 25, 2017, now abandoned.
(60) Provisional application No. 62/172,016, filed on Jun. 5, 2015.
(60) Provisional application No. 62/084,553, filed on Nov. 25, 2014.

(51) Int. Cl. E05C 17/04; E05C 17/30

(52) U.S. Cl. CPC E05C 17/042; E05C 17/30

(57) ABSTRACT

A device for holding the trunk lid of a vehicle in an open position, includes an elongated telescopic member adapted to be adjusted in length, a locking system for holding the elongated member in a selected position, and first and second holding mechanisms provided at opposed ends of the elongated member. The first and second holding mechanisms are adapted to be attached to a lower closed loop provided on the trunk sill and to an upper latching mechanism provided on the inside of the trunk lid of the vehicle.

### CROSS REFERENCE TO RELATED APPLICATIONS

This application claims priority on U.S. Provisional Application No. 62/084,553, now pending, filed on Nov. 25, 2014, and on U.S. Provisional Application No. 62/172,016, now pending, filed on Jun. 5, 2015, which are both herein incorporated by reference.

### FIELD

The subject matter of the present disclosure relates to supports for automobile trunk lids and, more particularly, to detachable for temporarily maintaining a trunk lid in an open position, typically to transport objects in the trunk, which are of a size such that they do not allow the trunk lid to be completely closed.

### BACKGROUND

Automobile trunks are conceived for accommodating various quantity of cargo. The overall amount of trunk space is limited by various design features of the vehicle, such as the rear deck, which needs to extend sufficiently above the ground, and the elevation of the trunk lid, which typically is below the rear windshield for visibility purposes.

When large objects (e.g. lumber, furniture, boxes, etc.) are placed in the trunk of the vehicle, it happens frequently that the trunk lid cannot be fully closed. In such cases, in order to try to prevent the trunk lid from bouncing up and down as the vehicle is driven and possibly damaging the trunk lid and/or the objects carried ion the trunk, the vehicle operator often resorts to using a rope to tie down the trunk lid on top of the load to be transported. The rope is typically attached to the trunk lid, for instance adjacent to or at the spring-loaded latch thereof, and to the trunk sill, typically to the closed end loop provided thereat, and which is normally engaged by the latch of the trunk lid when the trunk lid is in its closed position. The rope is also often attached to the vehicle's rear bumper and to the trunk lid.

The use of ropes is often not ideal in that they generally cannot be made fully taut, whereby the trunk lid may have some play to move L p and down. This may cause noise, damage the objects or the trunk lid and ever allow the load to partly or completely fall off the vehicle, and this may be hazardous to other vehicles.

Furthermore, it is not always easy to find suitable tie down locations for the ropes.

Instead of ropes, some devices use straps, for instance having adjustable lengths

Other devices and systems have been proposed for use when a trunk lid cannot be completely closed and latched to the trunk sill. For example, U.S. Pat. No. 6,029,941 issued to Mayzes on Feb. 29, 2000 discloses a device to secure a trunk lid in an open position. The device includes a telescoping shaft with two ends that secure the two portions of the latching system of an automobile, wherein most automobiles have a pair of jaws on one part of the latching system and a transverse rod on the other part of the latching system. When the trunk lid is closed normally, the jaws grip the rod to lock the trunk lid in its fully closed position. In Mayzes, one end of the device has a loop to secure within the jaws and the other end of the device has a notch and a locking pin to straddle and secure itself to the rod. Keys are tightened to secure in the desired positions the various sections of the telescoping shaft.

U.S. Pat. No. 4,667,993 issued to Hannesson et al. on May 26, 1987 describes a trunk lid holding device that includes a cylindrical tube carrying a spring inside with a hook (e.g. a S-hook) on one end to engage the fixed trunk hasp, and a ring or closed loop (e.g. U-shaped) on the other end to be lockably engaged by the trunk latching mechanism usually carried on the trunk lid. Once the hook is engaged with the fixed ring of the trunk, the lower end of the tube is manipulated so that a pair of opposed slots in the lower end of the wall of the tube engage upon the ring or hasp of the trunk so that the spring is under relatively heavy tension and thus acts as a substantially rigid link when the trunk lid is closed and locked upon the other end of the spring.

U.S. Pat. No. 5,320,398 issued to Popp et al. on Jun. 14, 1994 discloses a tie-down mechanism for pivotally mounted automobile trunk lids for use when objects in the trunk are too large to allow the lid to be completely closed. The mechanism includes a reel journaled for rotation on a reel housing which is attached to the underside of the trunk lid. A flexible strap wound on the reel spool is provided with a fastener on its free end. A ratchet and pawl mechanism mounted on the reel housing includes a pawl which is normally spring biased to lock the ratchet and reel against rotation in the unwinding direction. The reel is releasable by manual retraction of the pawl from engagement with the ratchet and the pawl held in the disengaged position by cooperation of a holding pin on the pawl and a shoulder on the pawl carrier. With the reel released, the strap can be withdrawn from the reel and its free end secured to an anchoring element in the trunk, such as to a keeper mounted atop the rear wall of the trunk compartment. The reel can then be manually rotated to tighten the strap, preferably when the pawl is released to engage the ratchet, such that the trunk lid tightly engages the objects in the trunk. By release of the pawl, the reel is locked against rotation in the unwind direction. It may then be rotated in the wind-up direction and the strap made taut to thereby secure the trunk lid in its tightly engaged position.

U.S. Pat. No. 4,870,925 issued to Troutman on Oct. 3, 1989 describes an apparatus for containing a pet in a partially open car trunk lid. Grillwork, including adjustable rear and side members, is adapted in size or the particular vehicle. The rear member is removably secured to the underside of the car trunk lid and the side members are rotatably mounted to opposite sides of the rear member. The distal ends of the side members rest in the trunk rain trough and are slidable therein so that the trunk lid may be fully opened without removing g the grillwork. Means are provided for securing the grillwork in a fixed position when the trunk is partially closed.

It would thus be desirable to be provided with a system and/or method, which would at least partly address the disadvantages of the existing technologies.

### SUMMARY

It would thus be desirable to be provided with a novel device for holding the trunk lid of a vehicle in an open position.

The embodiments described herein provide in one aspect a device for holding a trunk lid of a vehicle in an open position, comprising:
an elongated member adapted to be adjusted in length;
a locking system for holding the elongated member in a selected position; and
first and second holding mechanisms provided at ends of the elongated member, the first and second holding mechanisms being adapted to be attached to a closed loop and top an upper latching mechanism, which are provided on one and the other of a sill of a trunk of the vehicle and of the trunk lid of the trunk of the vehicle.

The embodiments described herein provide in another aspect a method for attaching a device between a trunk lid of a vehicle and a trunk sill of the vehicle for maintaining the trunk lid in an open position, comprising:
engaging a first end of the device on a vehicle latching mechanism;
displacing a second end of the device towards a vehicle loop while extending an elongated member of the device;
engaging the second end of the device to the vehicle loop;
locking the elongated member in a selected position for maintaining the trunk lid at a desired distance from the trunk sill.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a perspective view of a device for holding the trunk lid of a vehicle in an open position according to one of various exemplary embodiments, the device being shown in a retracted position;

FIG. 2 is a schematic view of the device of FIG. 1 in an extended position thereof and mounted to a trunk sill and trunk lid of a vehicle;

FIG. 3 is a top plan view of the device of FIG. 1;

FIG. 4 is a top plan view of the device of FIG. 1 shown in a fully extended position thereof;

FIG. 4a is a cross-sectional view of FIG. 4;

FIG. 5 is an exploded view of the device of FIG. 1;

FIGS. 6 to 11 are various plan views, some partly in cross-section, showing various components of the device of FIG. 1 and an assembly thereof;

FIG. 12 is an exploded view of an upper loop of the device of FIG. 1;

FIG. 13 is a perspective view of the upper end of the device of FIG. 1, which shows the upper loop of FIG. 12 in an assembled position thereof;

FIG. 14 is a schematic view showing the device of FIG. 1 in the process of having a lower latching mechanism thereof attached to a closed loop provided in a trunk sill of the vehicle;

FIG. 15 is an enlarged perspective view of part of FIG. 14;

FIG. 16 is an exploded view of the lower latching mechanism of the device of FIG. 1;

FIGS. 17 and 18 are sequential front elevation views showing an installation of the lower latching mechanism of the device of FIG. 1 to the closed loop of the trunk sill of the vehicle;

FIGS. 17a and 18a are sequential front elevation views showing an installation of the lower latching mechanism of the device of FIG. 1 to the closed loop of the trunk sill of the vehicle, the closed loop shown in FIGS. 17a and 18a having a different configuration than that shown in FIGS. 17 and 18;

FIG. 19 is a front elevation view showing how the lower latching mechanism of the device of FIG. 1 can be disengaged from the closed loop of the trunk sill;

FIG. 20 is a schematic view showing the device of FIG. 1 in the process of being extended for subsequent attachment to a latching mechanism of the trunk lid of the vehicle;

FIG. 21 is a schematic view showing the device of FIG. 1 in the process of having the upper loop thereof being attached to the latching mechanism of the trunk lid of the vehicle;

FIGS. 22 and 23 are sequential perspective views showing an installation as in FIG. 21 of the upper loop of the device of FIG. 1 to the latching mechanism of the trunk lid of the vehicle;

FIG. 24 is a schematic view, partly in cross-section, showing the device of FIG. 1 attached to the latching mechanism of the trunk lid of the vehicle;

FIG. 25 is a schematic view showing the device of FIG. 1 in the process of being retracted up to a desired position of the trunk lid relative to the trunk sill of the vehicle;

FIGS. 26 to 32, 33a and 33b are elevation views, some partly in cross-section, showing a series of variant configurations for the upper loop of the device according to various exemplary embodiments;

FIGS. 34, 34a and 34b are schematic views of a further variant of the upper loop of the device according to another exemplary embodiment;

FIGS. 35a and 35b are top plan and side views of a further device for holding the trunk lid of a vehicle in an open position according to one of various exemplary embodiments, the device being shown in an extended position;

FIGS. 36a, 36b and 36c are top plan, side and perspective views of the device of FIGS. 35a and 35b, but shown in a retracted position;

FIG. 37 is an exploded view of the device of FIGS. 35a and 35b;

FIGS. 38a, 38b and 38c are front, side and perspective detail views of an upper loop of the device of FIGS. 35a and 35b;

FIG. 39 provides a series of detail views of an end cap for a handle of the device of FIGS. 35a and 35b;

FIGS. 40a, 40b, 40c and 40d are perspective, side, rear and cross-sectional (taken along line 40d-40d of FIG. 40c) detail views of a handle of the device of FIGS. 35a and 35b;

FIG. 41 provides a series of detail views of a first tube of the device of FIGS. 35a and 35b;

FIG. 42 provides a series of detail views of a second tube of the device of FIGS. 35a and 35b;

FIG. 43 provides a series of detail views of a third tube of the device of FIGS. 35a and 35b;

FIG. 44 provides a series of detail views of a wedge of the device of FIGS. 35a and 35b;

FIG. 45 provides a series of detail views of a cam lever of the device of FIGS. 35a and 35b;

FIG. 46 provides a series of detail views of a first stopper of the device of FIGS. 35a and 35b;

FIG. 47 provides a series of detail views of a first collar of the device of FIGS. 35a and 35b;

FIG. 48 provides a series of detail views of a second collar of the device of FIGS. 35a and 35b;

FIG. 49 provides a series of detail views of a first latch cover of the device of FIGS. 35a and 35b;

FIG. 50 provides a series of detail views of a second latch cover of the device of FIGS. 35a and 35b;

FIG. 51 provides a series of detail views of a latch of the device of FIGS. 35a and 35b;

FIG. 52 provides a series of detail views of a trigger of the device of FIGS. 35a and 35b;

FIG. 53 provides a series of detail views of an opposing latch of the device of FIGS. 35a and 35b;

FIG. 54 provides a series of detail views of a return spring of the device of FIGS. 35a and 35b;

FIG. 55 provides a series of detail views of a release tension spring of the device of FIGS. 35a and 35b; and

FIG. 56 provides a series of detail views of a knurled spring of the device of FIGS. 35a and 35b.

### DESCRIPTION OF VARIOUS EMBODIMENTS

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

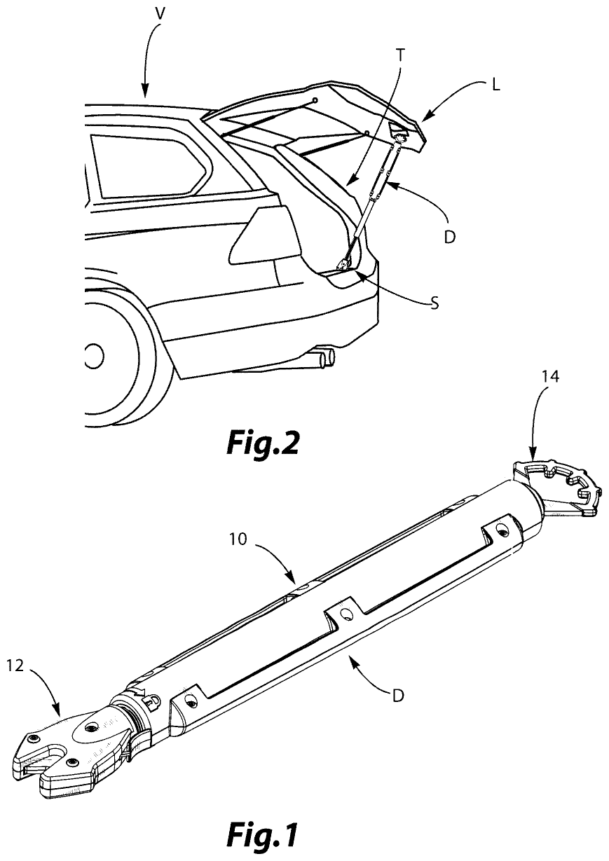

Referring now to FIGS. 1 and 2, therein illustrated is a perspective view of a device D for holding a lid L of a trunk T of a vehicle V in an open position according to various exemplary embodiments, the device D being shown in a retracted position. The device D has a telescopic body 13 and includes at opposed ends thereof a lower latching mechanism 12 and an upper loop 14.

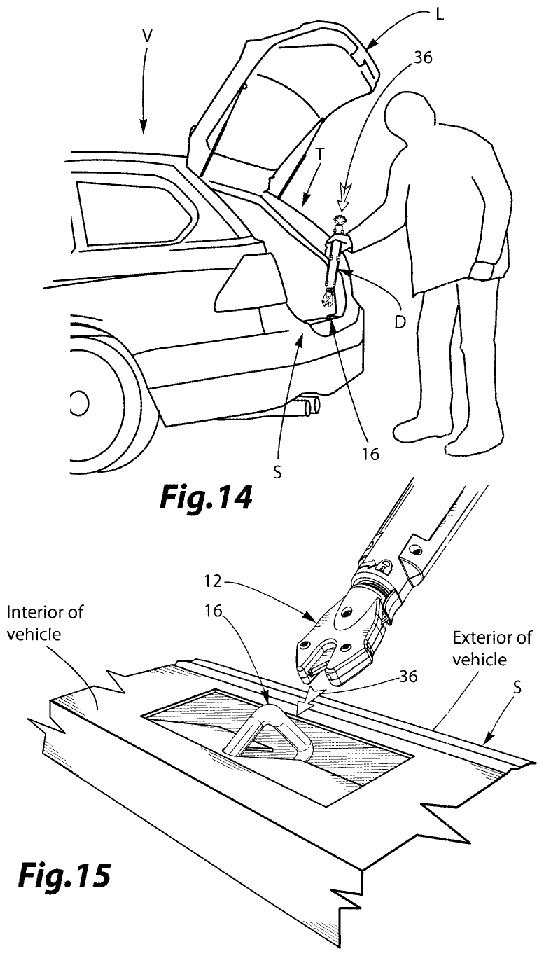

The latching mechanism 12 is adapted to be connected to a closed loop 16 (see FIGS. 14 and 15) mounted in a sill S of the trunk T of the vehicle V. The upper loop 14 is adapted to be connected to an upper latching mechanism 18 (see FIGS. 21 to 23) mounted in the trunk lid L of the trunk T of the vehicle V.

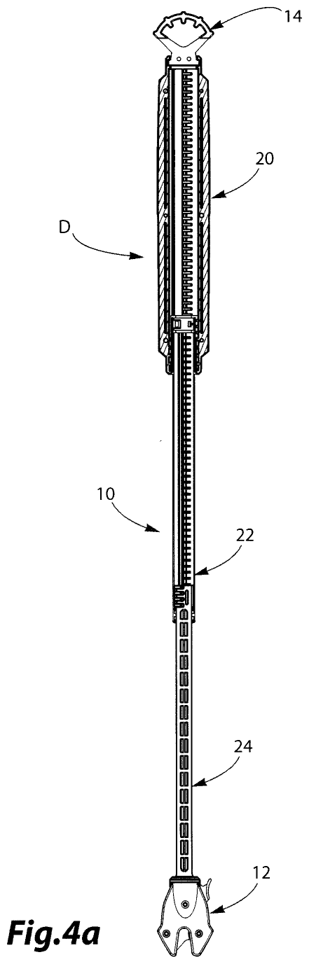

FIGS. 4 and 4a show the device D in a fully extended position thereof, thereby illustrating an upper section 20, an intermediate section 22 and a lower section 24 of the telescopic body 10. The lower latching mechanism 12 is fixedly mounted to the lower section 24, whereas the upper loop 14 is rotatably mounted to the upper section 20 such that it can rotate or swivel about a longitudinal axis of the device D. The upper section 20 and the lower section 24 can be locked to the intermediate section 22 by relative rotation of these two pairs of components such that the telescopic body can adopt a multitude of positions between the fully retracted position of FIG. 1 and the fully extended position of FIG. 4.

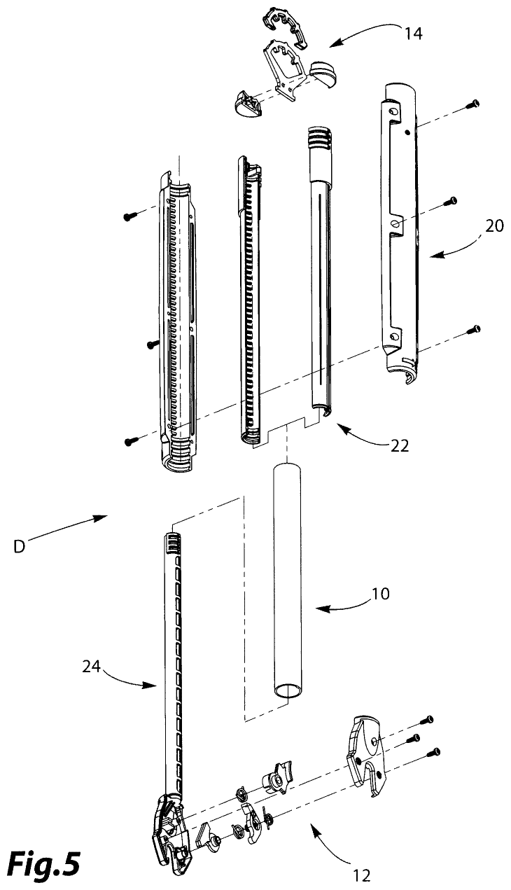

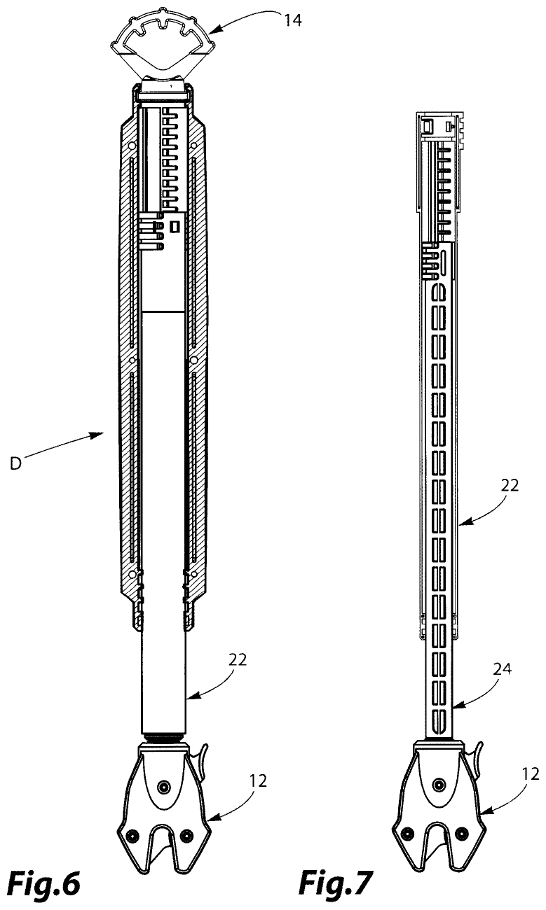

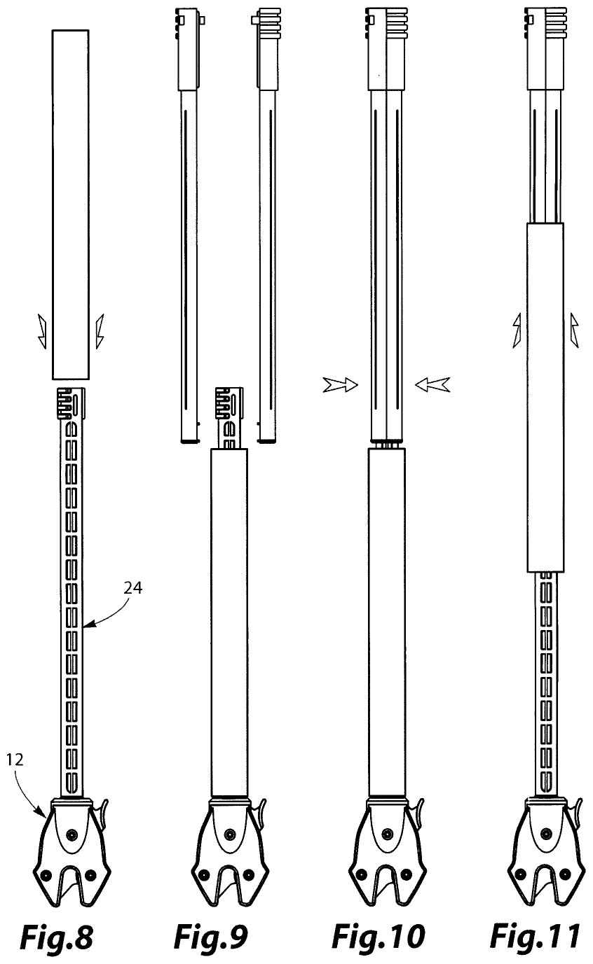

FIG. 5 shows the device D in an exploded view. FIGS. 6 to 11 are various plan views, some partly in cross-section, showing different components of the device of FIG. 1 and an assembly thereof.

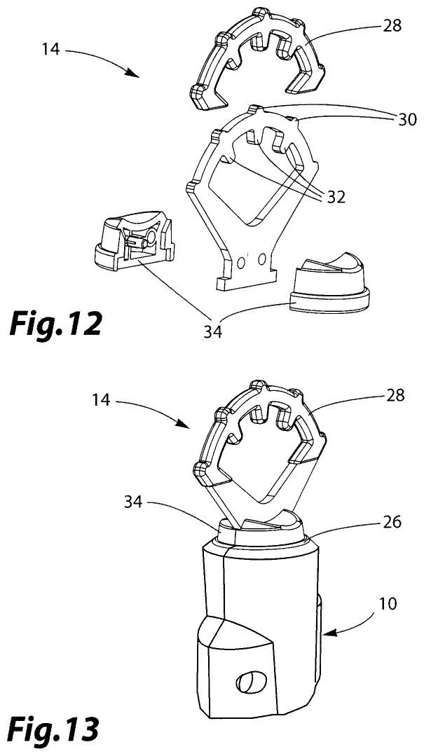

FIGS. 12 and 13 show details of the upper loop 14, including the 360° swivel thereof, indicated at 26, with respect to the telescopic body 10. The loop 14 defines outer guiding bumps 30 and inner sliding limiters 32 in order for the loop 14 to adapt to various configurations of latching mechanisms 18 that can be found in different vehicles V. A protective cover 28 is provided on the metallic base of the upper loop 14, the cover 28 being made for instance of neoprene. The reference 34 denotes the 2-part base of the loop 14, which is rotatably mounted at 26 to the telescopic body 10.

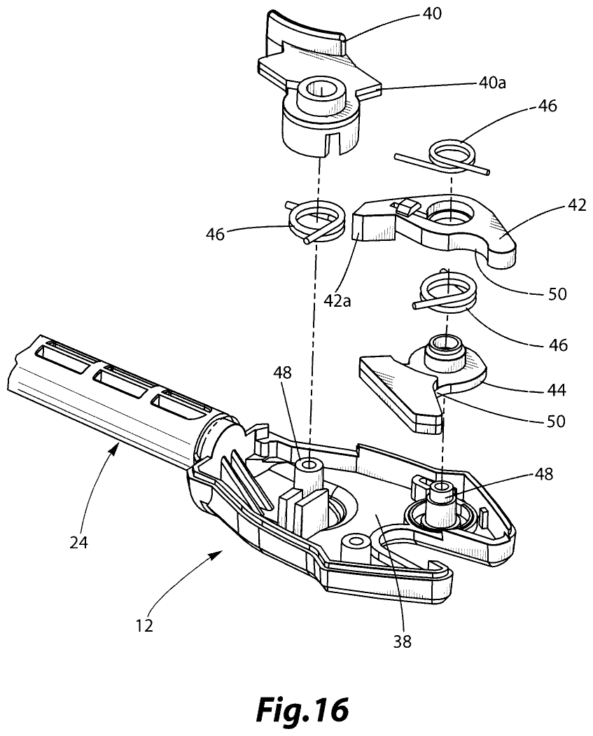

Details of the lower latching mechanism 12 are shown in FIGS. 16, 17, 17a, 18, 18a and 19 and will be understood via the installation steps described below of the lower latching mechanism 12 to the closed loop 16 of the trunk sill S of the vehicle V.

With reference to FIGS. 14 and 15, the lower latching mechanism 12 is brought to the closed loop 16 and forcedly engaged thereon by pushing the device D as per arrow 36. As seen in FIGS. 16 to 18, the main components of the lower latching mechanism 12 are: a latch cover or casing 38, a trigger 40, a first latch 42 and a second opposing latch 44, with the latter three parts being all spring-loaded (see springs 46) and being rotatably mounted in the casing 38 (onto fixed rollers 48). The trigger 40 and the first latch 42 include cooperating locking abutments 40a and 42a, respectively.

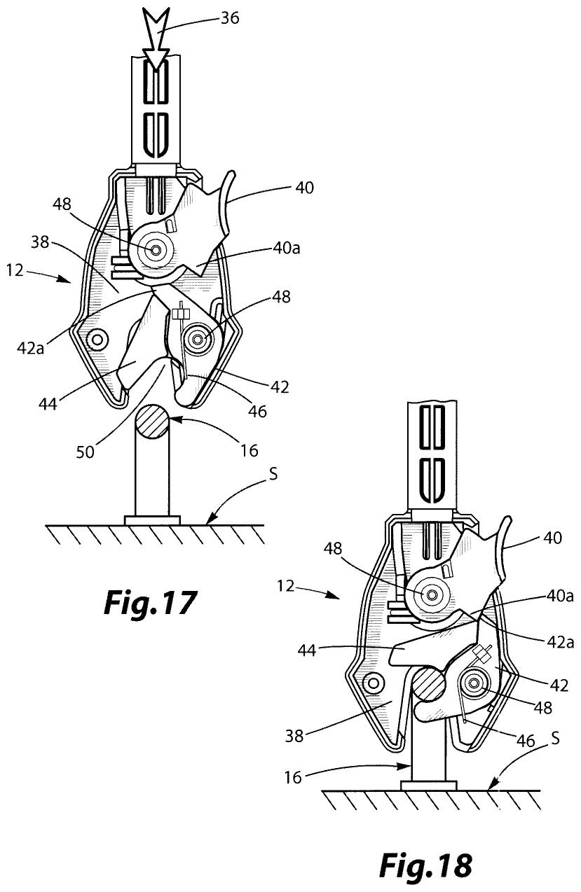

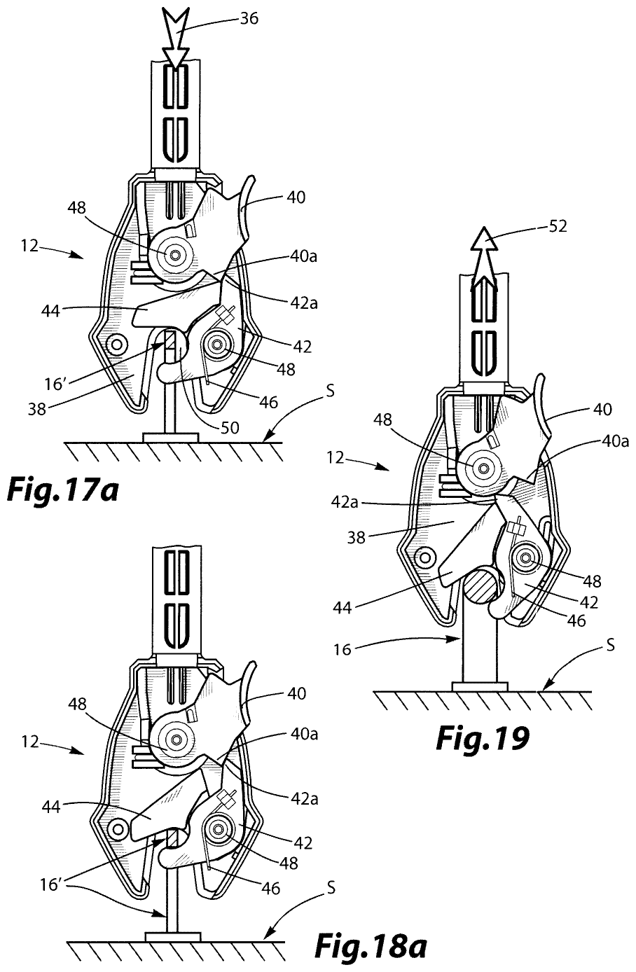

As seen in FIG. 17, in a release position, the latching mechanism 12 is adapted to allow the closed loop 16 of the trunk sill S to access a curved notch 50 defined by and between the first and second latches 42 and 44. As the device D is further pushed onto the closed loop 16, the closed loop 16 moves the first and second latches 42 and 44 to the positon shown in FIG. 18, the second opposing latch 44 pushing the first latch 42 to a lock point, wherein the cooperating locking abutments 40a and 42a become engaged together. The closed loop 16 is thus locked to the latching mechanism 12.

FIGS. 17a and 18a illustrate how the latching mechanism 12 and, more particularly, the first and second latches 42 and 44 thereof are able to accommodate a closed loop 16′ of lesser transverse dimensions than the closed loop 16 of FIGS. 17 and 18. More particularly, as seen in FIG. 17a, the second opposing latch 44 pushes the first latch 42 all the way to the lock point. Now turning to FIG. 18a, the second opposing latch 44 being spring-loaded, it applies pressure on the closed loop 16′ to reduce, if not remove, any loose, i.e. the closed loop 16′ is imprisoned between the first and second latches 42 and 44.

FIG. 19 shows how to disengage the closed loop 16 from the latching mechanism 12, namely by depressing the trigger 40 so that the cooperating locking abutments 40a and 42a release from one another, and by pulling the device D as per arrow 52 away from the closed loop 16 and the trunk sill S. This forces the downward pivot of the first and second latches 42 and 44 and so allowing the closed loop 16 to slip out of the curved notch 50.

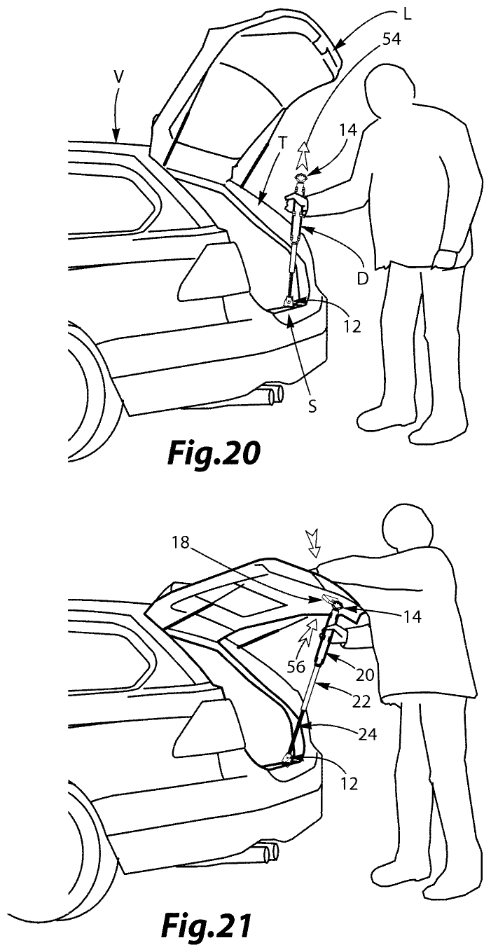

FIG. 20 shows the device D secured to the closed loop 16 of the trunk sill S via the latching mechanism 12, whereby the telescopic body 10 can now be extended by pulling on the deice D, as per arrow 54. It is possible that a relative counter-clockwise rotation is required between the body sections to free (unlock) the sections so as to allow them to slide from one another.

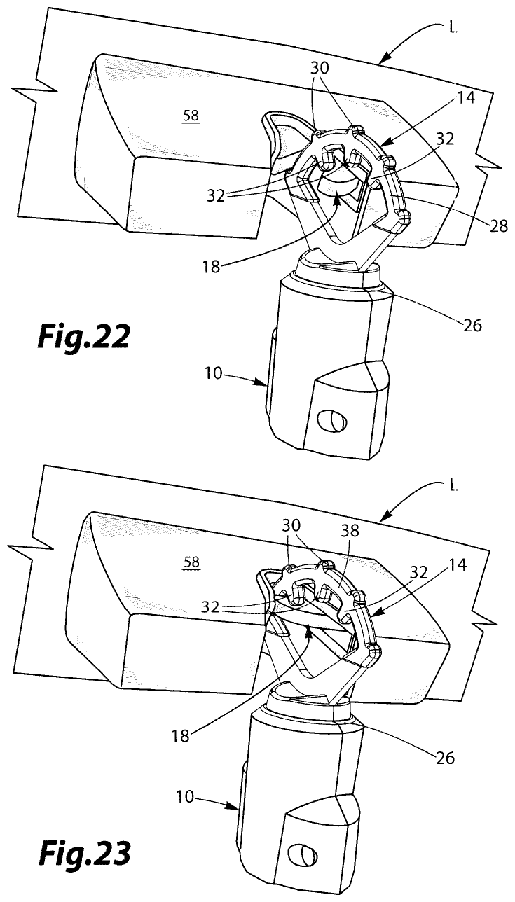

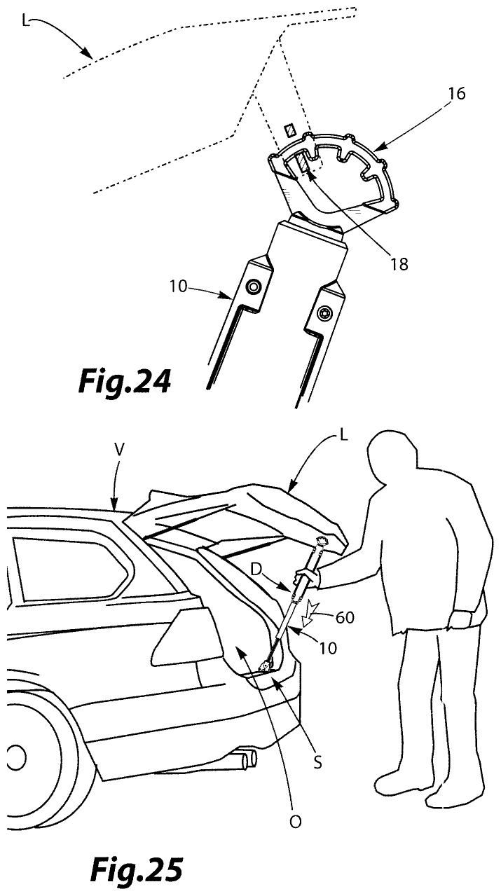

Now referring to FIGS. 21 to 24, the device D is pushed upwardly against the upper latching mechanism 18 of the trunk lid L, as per arrow 56 in FIG. 21. As seen in FIG. 22, the upper loop 14 is oriented properly via its swivel 26 and the latching mechanism 18, in an open position thereof, is engaged at an appropriate location relative to the outer guiding bumps 30 and inner sliding limiters 32 of the upper loop 14. In FIG. 23, the upper loop 14 is secured to the latching mechanism 18, which is now in a closed position thereof. FIG. 24 also shows the upper loop 14 locked to the latching mechanism 18. Reference 58 denotes a casing of the latching mechanism 18.

In FIG. 25, the telescopic body 10, with its sections unlocked, is retracted, as per arrow 60, until the trunk lid L is at the desired height and a desired trunk opening O has been obtained. Thereafter, the body sections are appropriately rotated clockwise, relative to one another, so that they become locked together. It is noted that the upper loop 14 is designed to accommodate a large number of different configurations of latching mechanisms 18 that can be encountered in various types of vehicles V. Various entry points, in the latching mechanism 18, are provided between each adjacent pairs of outer guiding bumps 30.

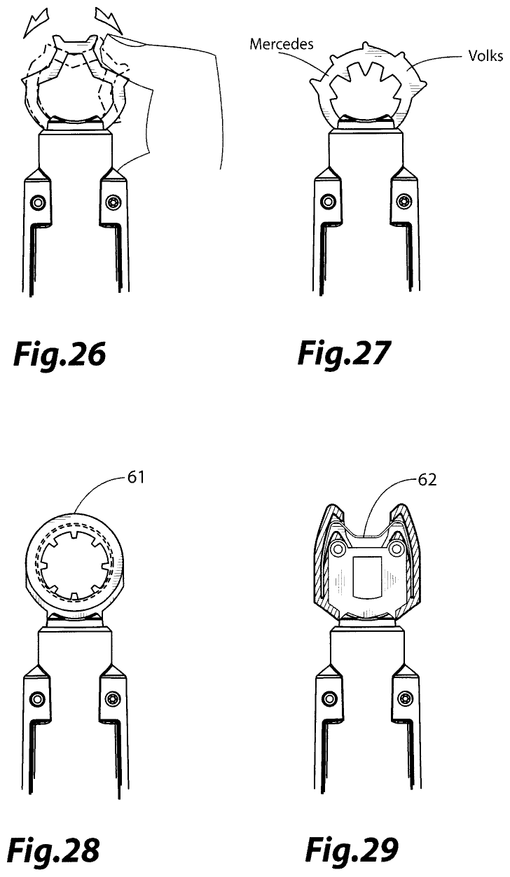

FIGS. 26 to 33b show variants of the upper loop 14. In FIG. 26, there is single entry point, but the upper loop is pivotable relative to the telescopic body 10. In FIG. 27, there are different entry points for different geometries of latching mechanisms 18; the loop has to be rotated to find the proper alignment with the vehicle latching mechanism 18.

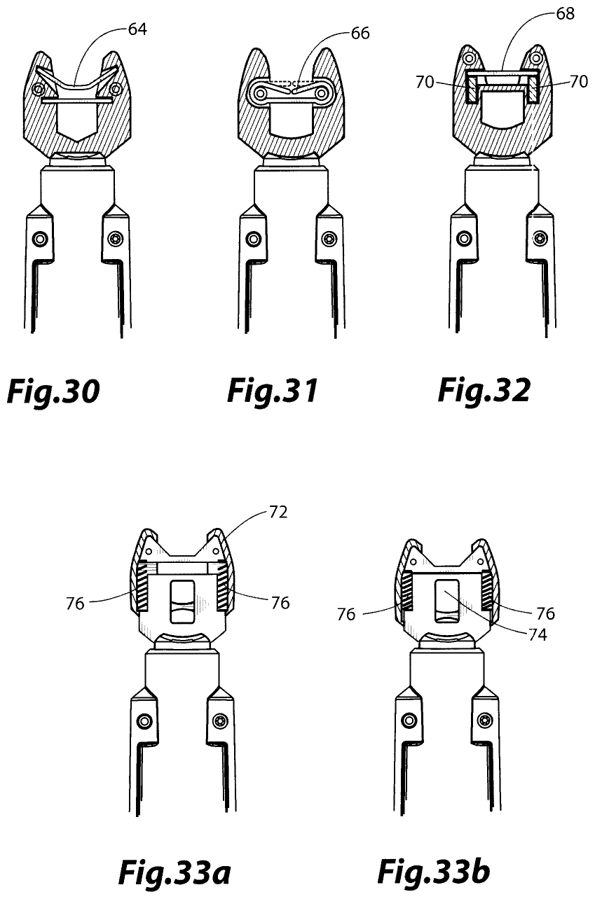

In FIG. 28, there are variable sections, and the ring 61 is rotatable to align the upper loop properly in view of the configuration of the vehicle latching mechanism 18. FIGS. 29 to 33b illustrate other upper loops 16, wherein in FIG. 29, a front part of a steel spring 62 flexes, compresses and pushes back to remove any loose. In FIGS. 30 and 31, there is a metal spring 64 and 66, respectively. In FIG. 31, the spring steel loop 66 flexes in front zone and pushes back to absorb any loose.

In FIG. 32, a metal rod 68 compresses elastomeric parts 70. In FIGS. 33a and 33b, a spring-loaded front part 72 compresses under pressure of the latching mechanism 18 while it engages but pushes back to remove any loose on latching mechanisms where opening 74 is wider. Reference 76 denotes springs.

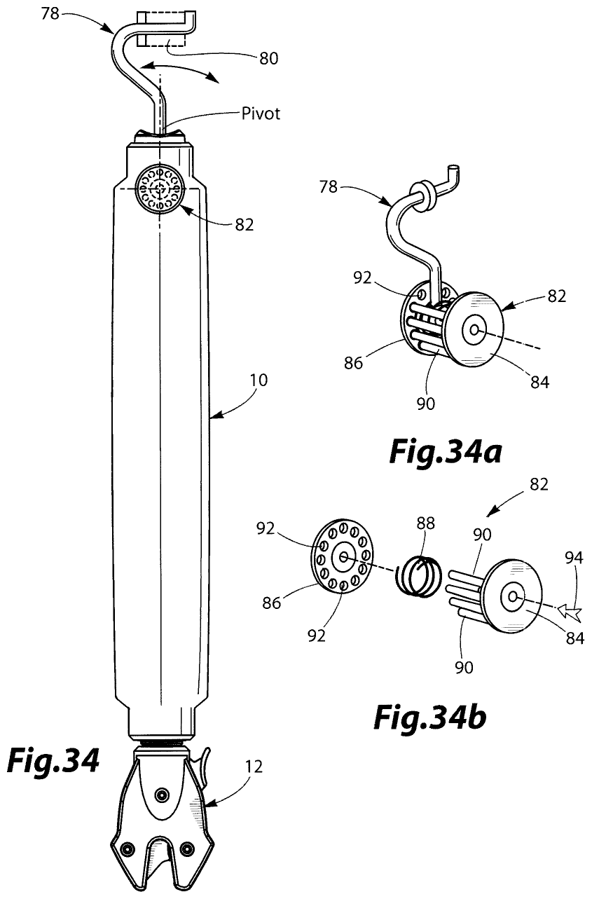

In FIGS. 34 to 34b, the upper loop 14 is rather a hook 78. Different adaptors 80 would be provided (for instance in a kit), for example a sleeve made of neoprene or urethane, for adapting the diameter of the end of the hook 78 to the different configurations of latching mechanisms found in various vehicles. The hook 78 can pivot relative to the body via control button 82, which includes a pair of circular plate-like male and female members 84 and 86 respectively, with a spring 88 being provided therebetween. The male member 84 includes projecting arms 90, and the female member 86 includes apertures 92. When the male member 84 is depressed along arrow 94, it retracts thereby freeing the projecting arms 90 from the apertures 92 and allowing the hook 78 to be pivoted to a desired position.

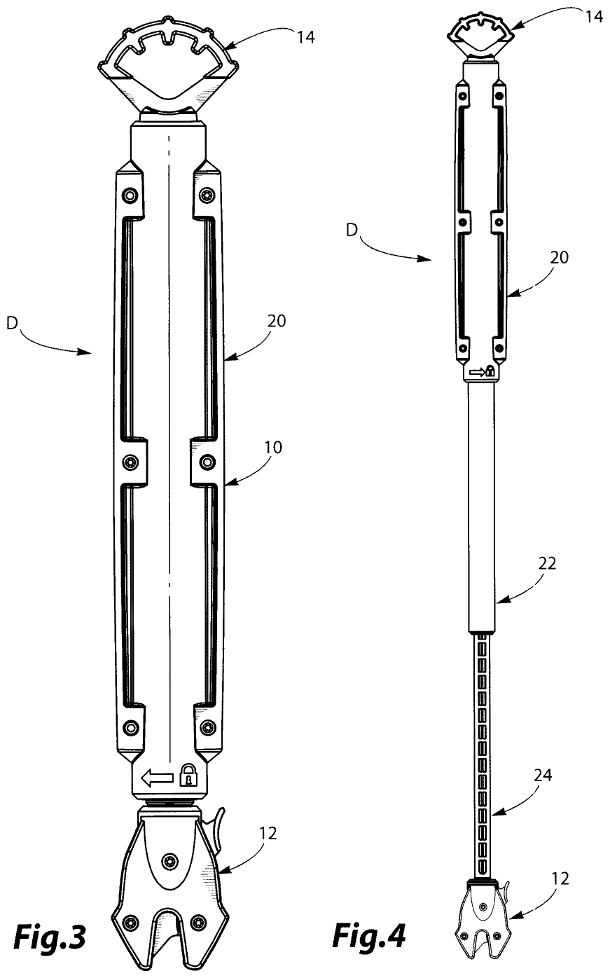

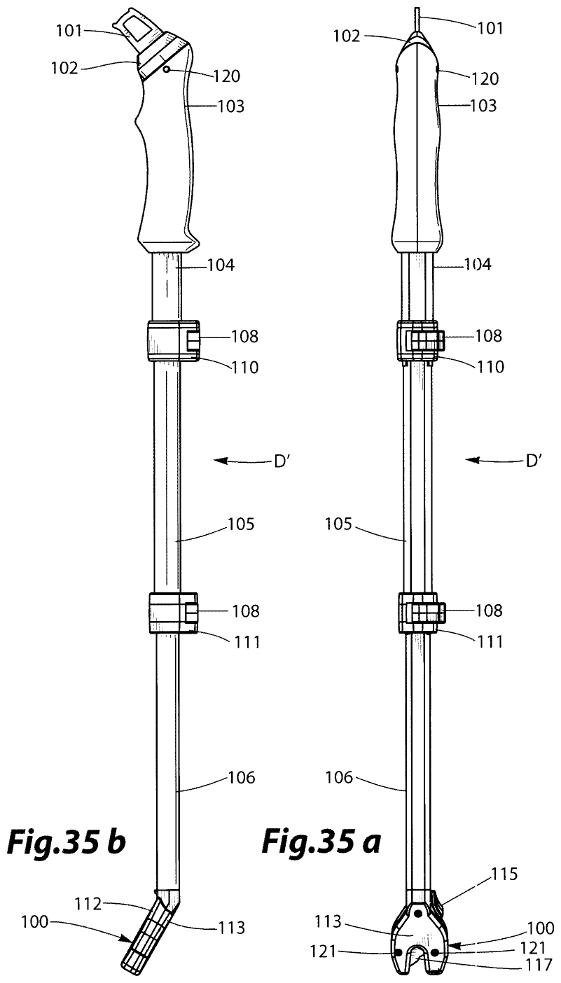

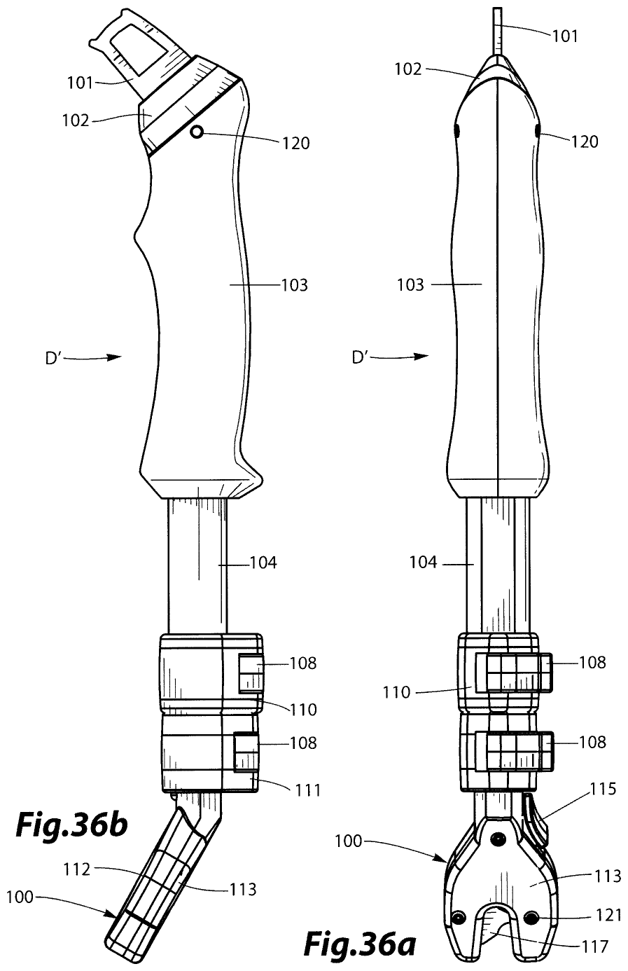

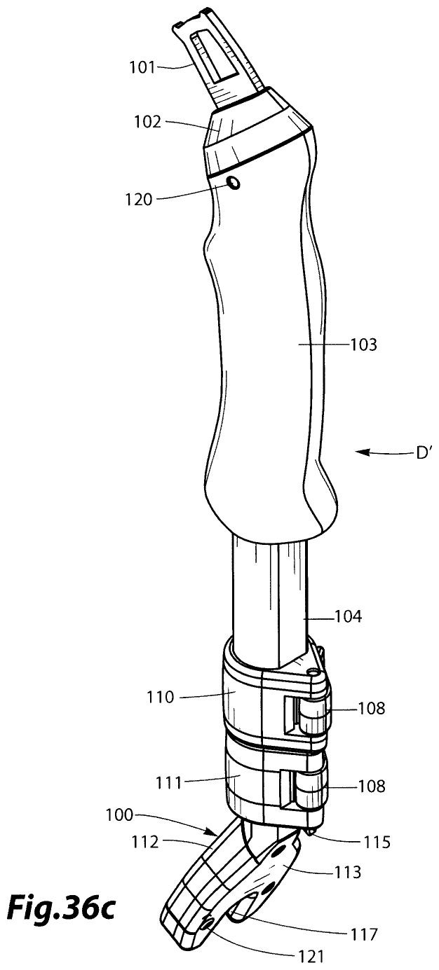

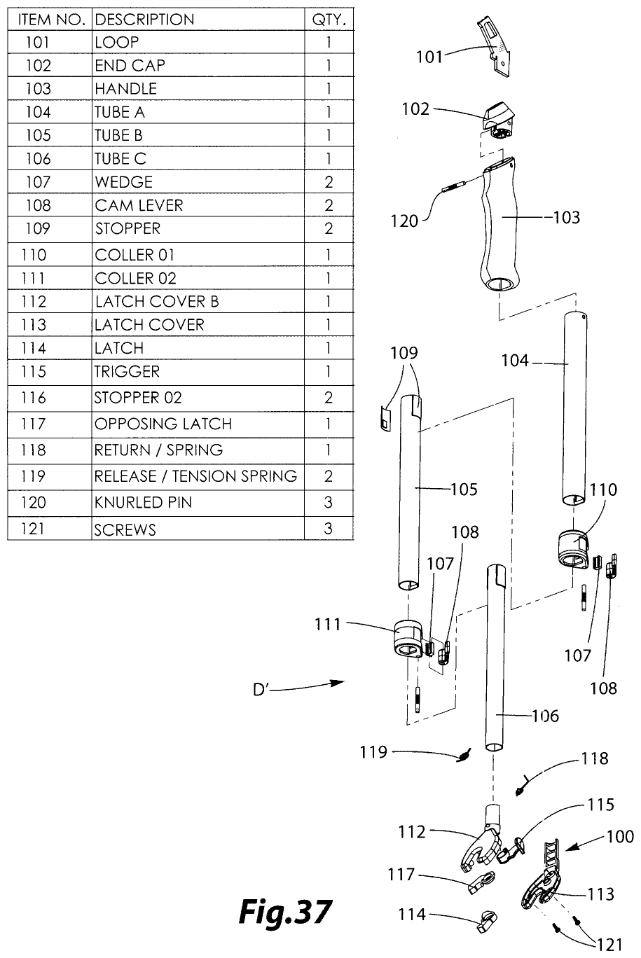

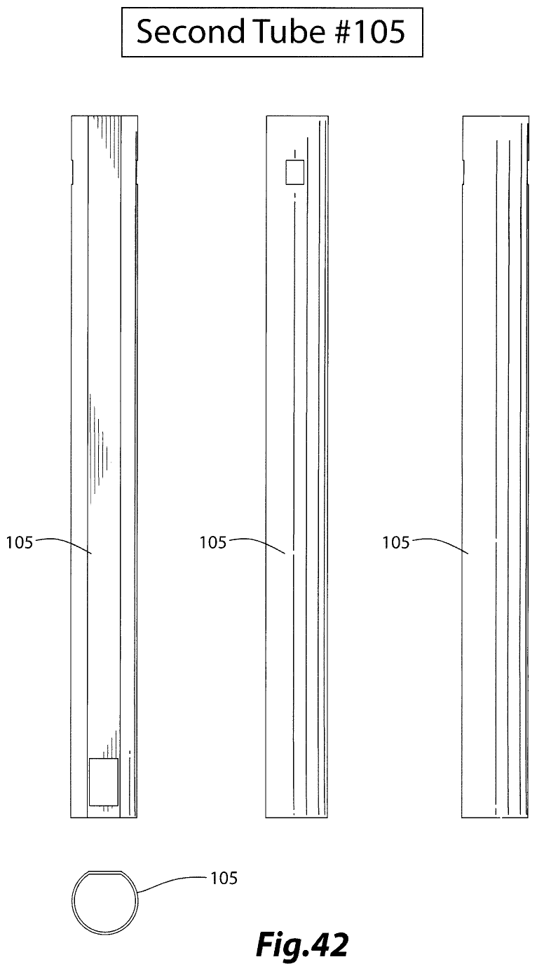

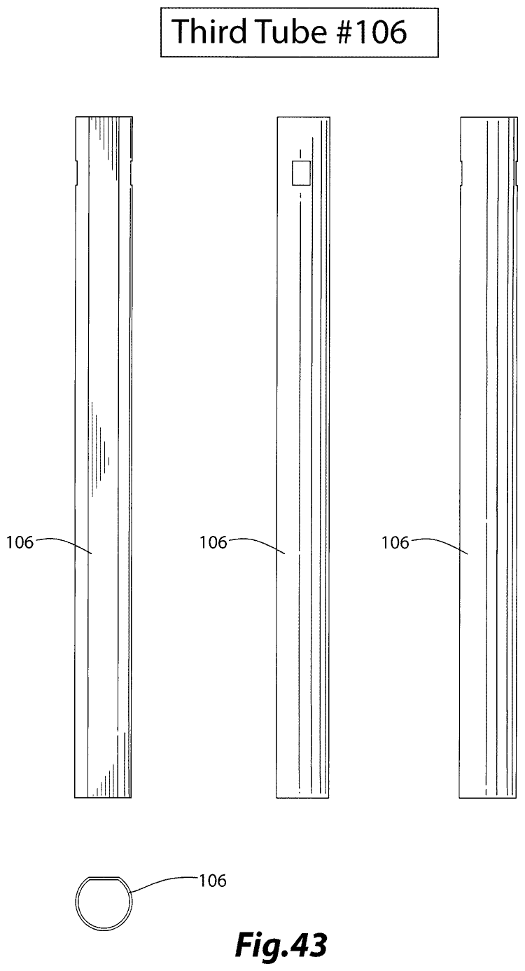

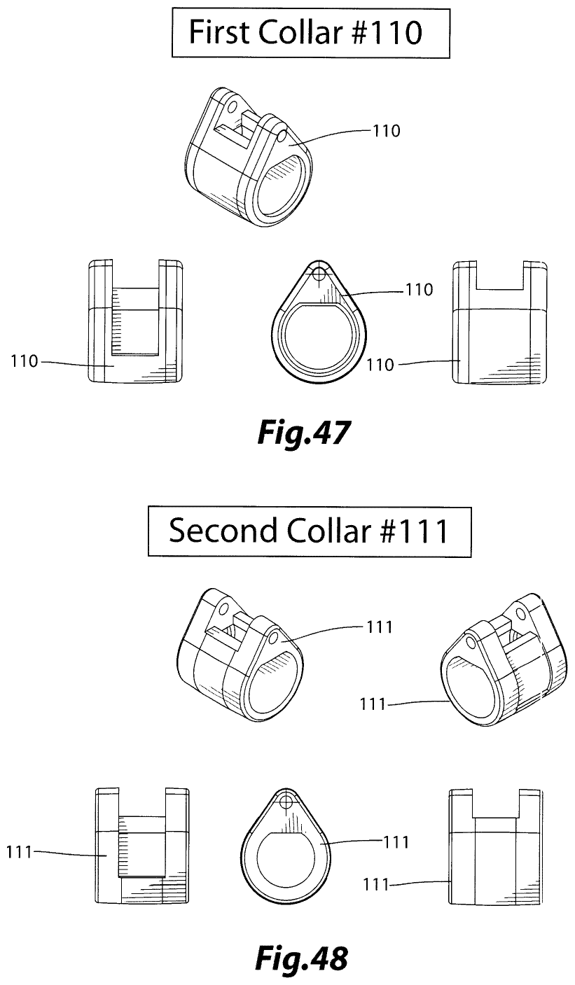

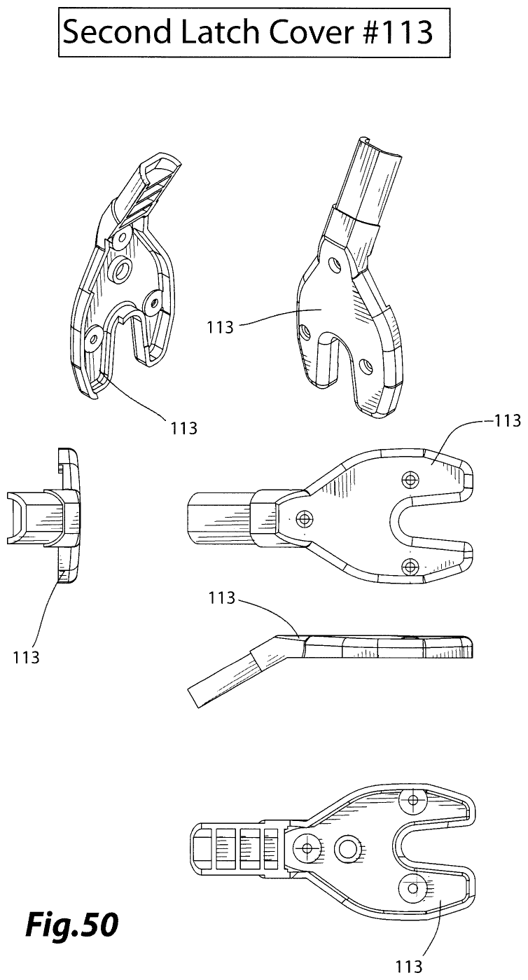

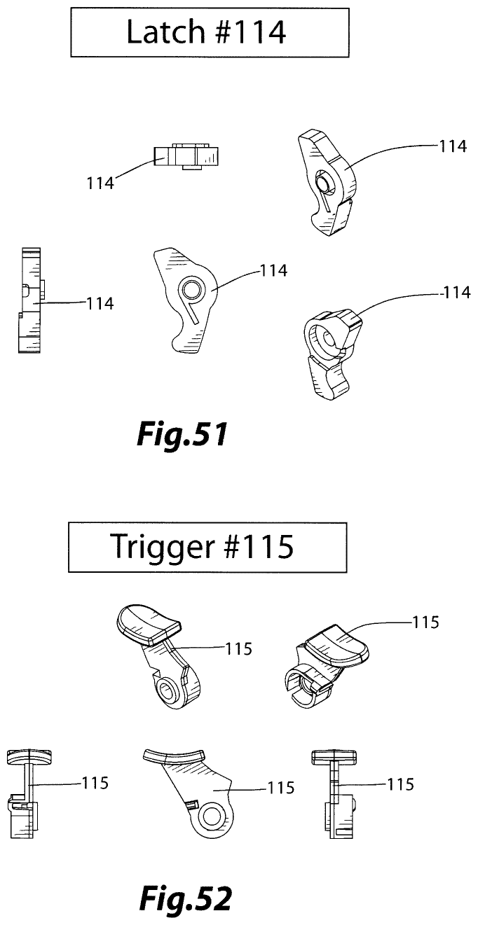

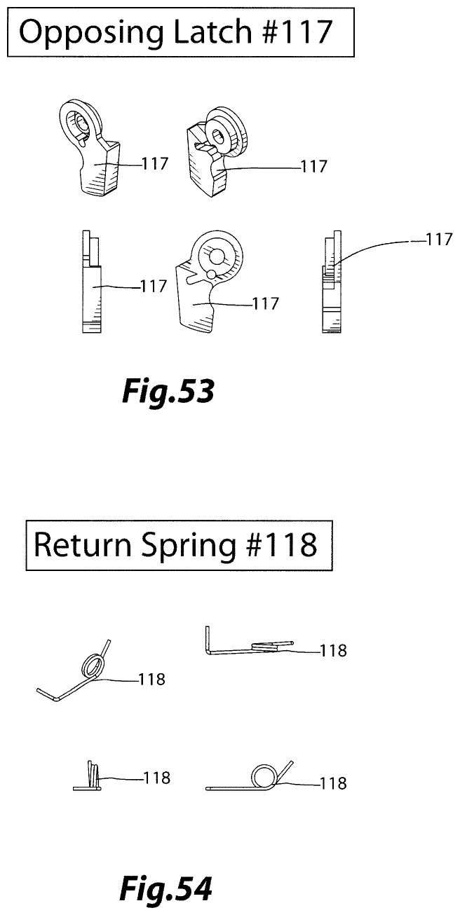

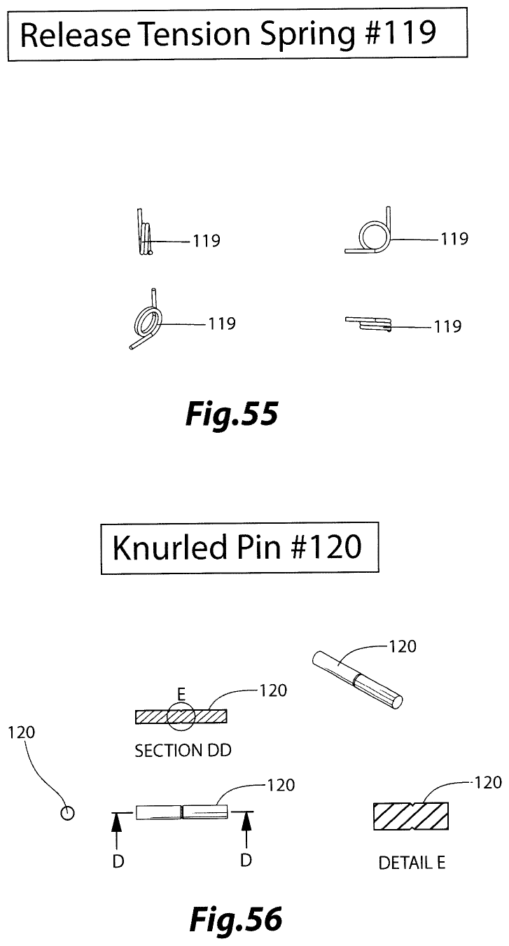

FIGS. 35a to 56 illustrate a variant device D′ for holding the trunk lid of a vehicle in an open position, which differs from the device D of FIGS. 1 to 34 in some aspects, but is similar in many others. The device D′ is shown in FIGS. 35a and 35b in an extended position thereof, whereas it is shown in a retracted position thereof in FIGS. 36a, 36b and 36c. FIG. 37 illustrates the device D′ in an exploded view.

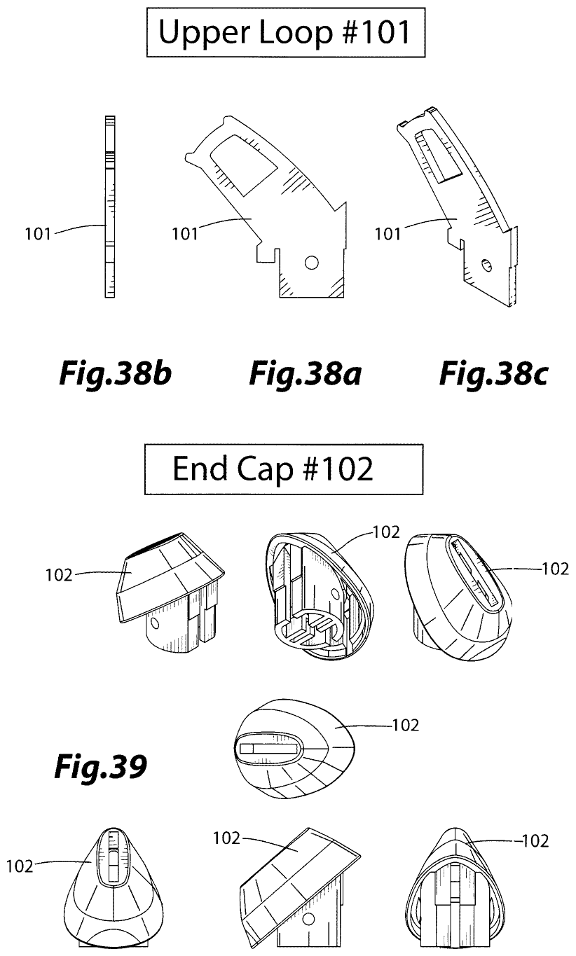

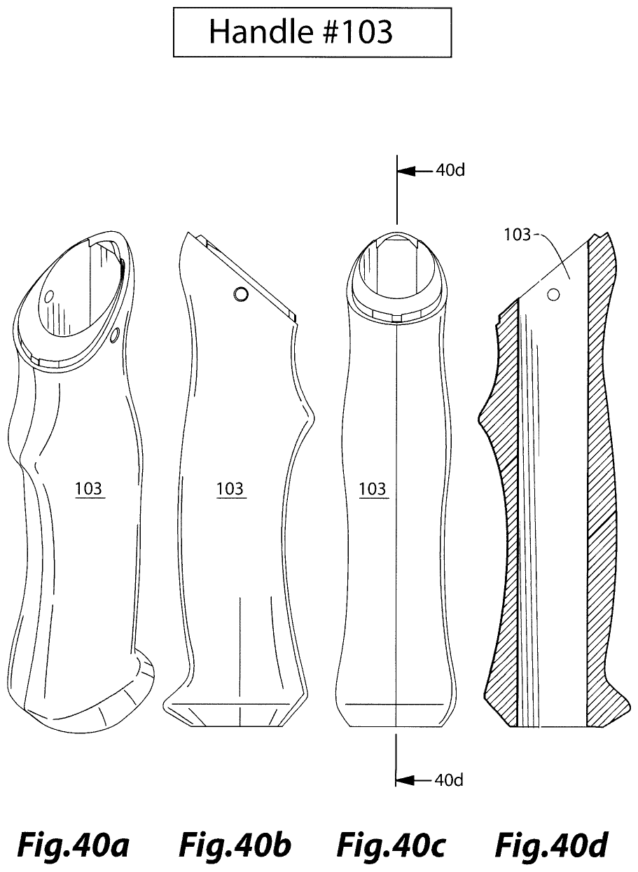

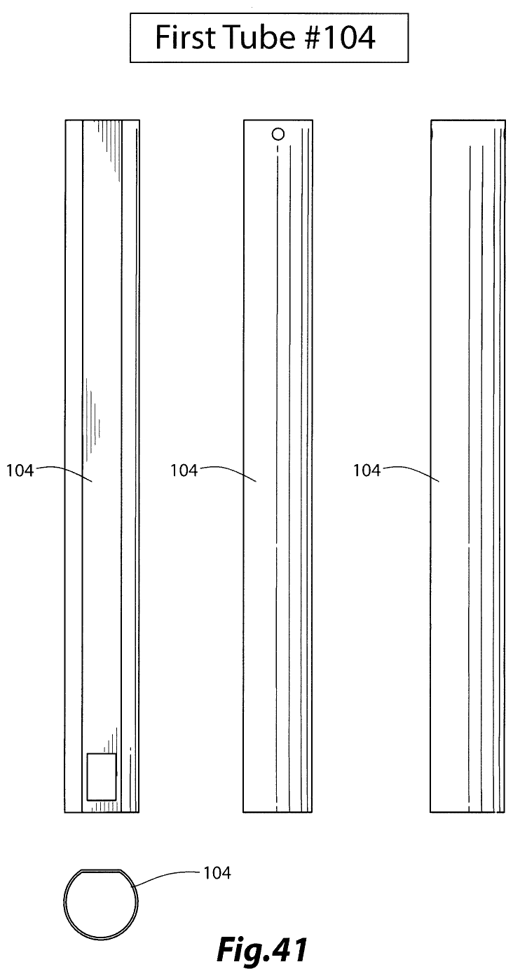

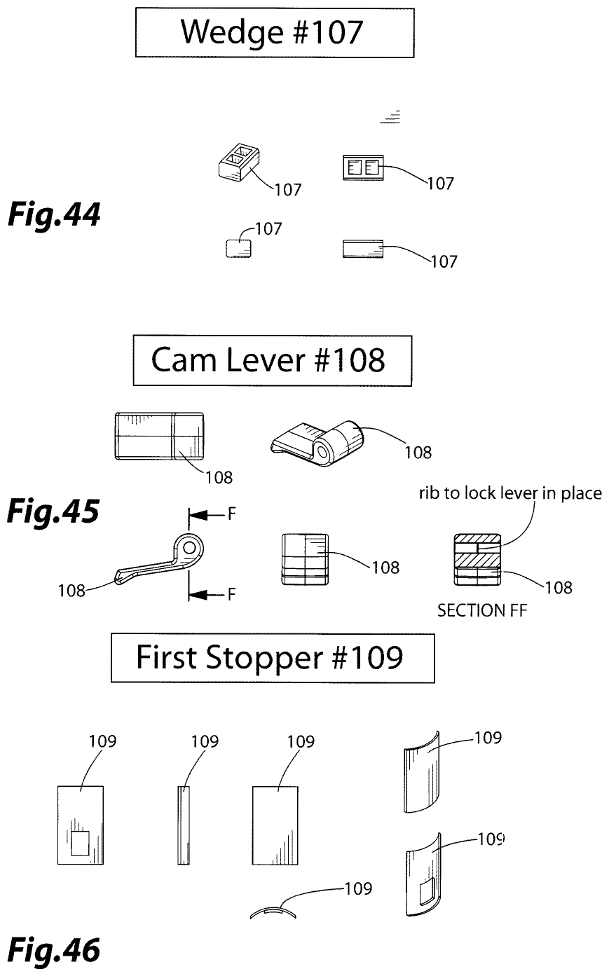

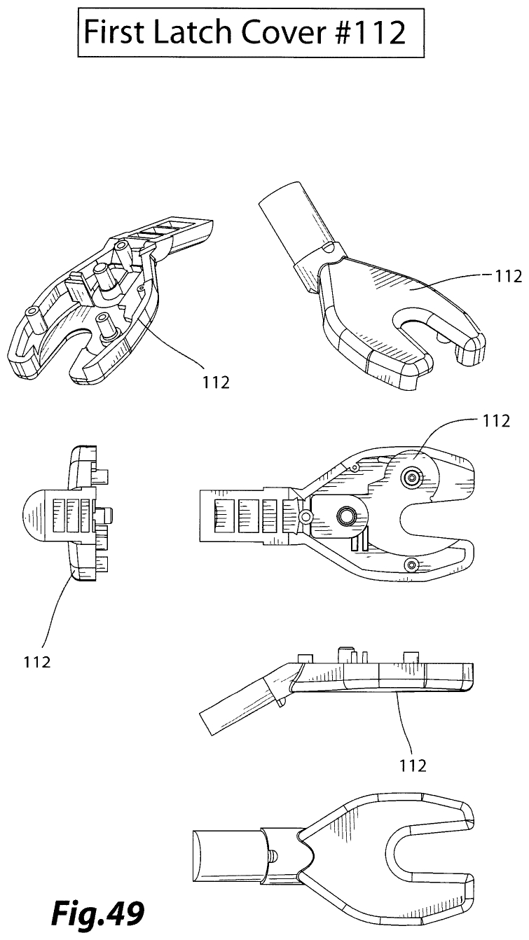

FIGS. 38 to 56 provide multiple detail views of a series of the individual parts of the device D′, as follows:
an upper loop 101 in FIGS. 38a, 38b and 38c, which in function is similar to the upper loop 14 of the device D, but which is simpler while being adapted to be connected to a large number of upper latching mechanisms 18 of many vehicles;
a handle 103 in FIGS. 40a, 40b, 40c and 40d, which is shown herein as rigid, but which could be made of a resilient foam material; the handle 103 being provided at the end of the device D′ where the upper loop 101 is found;
and end cap 102 in FIG. 39, the upper loop 101 and the end cap 102 being mounted to the handle 103 with a knurled pin 120 (seen in FIG. 56);
a telescopic assembly made up of first, second and third tubes 104, 105 and 106, respectively, these components being shown in FIGS. 41, 42 and 43, respectively; stoppers 109 and 116 are provided and are shown in FIG. 46;
a locking assembly for the telescopic assembly, which includes a wedge 107, a cam lever 108 and first and second collars 110 and 111, respectively, these components being shown in FIGS. 44, 45, 47 and 48, respectively; and
a lower latching mechanism 100, which in function and construction is similar to the latching mechanism 12 of the device D, although having a larger gap between the fixed jaws so as to accommodate the lower closed loops 16 of a larger number of vehicles; the latching mechanism 100 includes a first latch cover 112, a second latch cover 113, a latch 114, a trigger 115, an opposing latch 117, a return spring 118 and a release tension spring 119, these components being shown in FIGS. 49, 50, 51, 52, 53, 54 and 55, respectively; with mounting screws 121 being shown in FIGS. 35a, 36a, 36c and 37.

It is noted that the first, second and third tubes 104, 105 and 106 of the telescopic assembly could define series of spaced apart parallel notches or grooves that are formed transversally therein and that are adapted to be engaged by the locking assemblies. Such a mating arrangement (of the male-female type) could provide a stronger grip for the locking assemblies on the telescopic assembly than a simple frictional abutment, thereby preventing any relative axial movement between the tubes 104, 105 and 106 when the locking mechanisms are in the locked positions thereof on the telescopic assembly. Since the vehicle V may hit some bumps and the like while the device D′ is holding the vehicle's lid L in an open position, the device D′ may become significantly solicited, whereby the locking mechanisms may be required to be able to firmly hold the telescopic assembly in position.

Finally, while the above description provides examples of the embodiments, it will be appreciated that some features and/or functions of the described embodiments are susceptible to modification without departing from the spirit and principles of operation of the described embodiments. Accordingly, what has been described above has been intended to be illustrative of the embodiments and non-limiting, and it will be understood by persons skilled in the art that other variants and modifications may be made without departing from the scope of the embodiments as defined in the claims appended hereto.

1. A device for holding a trunk lid of a vehicle in an open position, the device comprising:
an elongated member adapted to be adjusted in length;
a locking system for holding the elongated member in a selected position; and
first and second holding mechanisms provided on the elongated member, the first and second holding mechanisms being adapted to be attached to respective ones of a vehicle closed loop and a vehicle latching mechanism, in which the vehicle closed loop and the vehicle latching mechanism are provided on one and the other of a sill of a trunk of the vehicle and of the trunk lid of the trunk of the vehicle,
wherein the first holding mechanism includes a device latching mechanism adapted to engage the closed loop of the vehicle, and the second holding mechanism includes a device loop adapted to engage the vehicle latching mechanism of the vehicle, and wherein the device loop extends at a first angle from the elongated member such that the first angle is not coaxial to a longitudinal axis of the elongated member, and wherein the device latching mechanism extends at a second angle with respect to a longitudinal axis of the elongated member.

2. The device according to claim 1, wherein the first and second holding mechanisms are provided at opposed first and second ends of the elongated member, respectively.

3.-6. (canceled)

7. The device according to claim 11, wherein each section of the elongated member includes a rigid tubular member.

8.-10. (canceled)

11. A device for holding a trunk lid of a vehicle in an open position, the device comprising:
an elongated member adapted to be adjusted in length;
a locking system for holding the elongated member in a selected position; and
first and second holding mechanisms provided on the elongated member, the first and second holding mechanisms being adapted to be attached to respective ones of a vehicle closed loop and a vehicle latching mechanism, in which the vehicle closed loop and the vehicle latching mechanism are provided on one and the other of a sill of a trunk of the vehicle and of the trunk lid of the trunk of the vehicle,
wherein the elongated member includes at least first and second sections, which are telescopically mounted to each other, and wherein the locking system is displaceable between locked and unlocked positions, wherein in the locked position the first and second sections are secured together, whereas in the unlocked position the first and second sections can be slidably displaced relative to one another,
wherein the locking system is provided with a locking mechanism for each adjacent pair of sections of the elongated member, and wherein each locking mechanism includes a lever displaceable between the locked and unlocked positions and provided on an outside section of a pair of telescoped sections,
wherein the outside section of a pair of telescoped sections defines an opening with the lever being adapted, in the locked position, to extend though the opening and onto the inside section of a pair of telescoped sections thereby securing the inside and outside sections together, and
wherein the lever includes a cam portion adapted to engage the inside section of a pair of telescoped sections, and wherein each cam portion is adapted to exert pressure on an outside surface of the inside section of a pair of telescoped sections.

12.-16. (canceled)

17. The device according to claim 1, wherein the device latching mechanism is adapted to engage the vehicle lower closed loop provided at the trunk sill of the vehicle, and the device loop is adapted to engage the vehicle upper latching mechanism provided on the trunk lid of the vehicle.

18. The device according to claim 1, wherein the device latching mechanism includes a pair of jaws, at least one of which is mobile; the jaws being displaceable between open and closed positions, wherein in the open position the vehicle closed loop can be inserted between the jaws of the device latching mechanism, whereas in the closed position at least one of the two jaws extends behind the vehicle closed loop and the jaws are close enough together to prevent the vehicle closed loop from disengaging therefrom.

19. The device according to claim 1, wherein at least one of any mobile jaw is spring-loaded.

20. The device according to claim 19, wherein the spring-loaded jaw is biased towards the closed position.

21. The device according to claim 20, wherein the device latching mechanism includes a trigger adapted, when actuated, to displace the spring-loaded jaw to the open position for releasing the device latching mechanism from the vehicle closed loop.

22. A device for holding a trunk lid of a vehicle in an open position, the device comprising:
an elongated member adapted to be adjusted in length;
a locking system for holding the elongated member in a selected position; and
first and second holding mechanisms provided on the elongated member, the first and second holding mechanisms being adapted to be attached to respective ones of a vehicle closed loop and a vehicle latching mechanism, in which the vehicle closed loop and the vehicle latching mechanism are provided on one and the other of a sill of a trunk of the vehicle and of the trunk lid of the trunk of the vehicle, and
wherein jaws of the first holding mechanism are adapted to displace from a closed position thereof to an open position thereof when the first holding mechanism is forcibly pushed onto the vehicle closed loop, for allowing the vehicle closed loop to extend sufficiently into the first holding mechanism such that the jaws can then biasedly return to the closed position.

23. The device according to claim 1, wherein the device loop is adapted to engage the vehicle upper latching mechanism of the vehicle provided in the trunk lid thereof.

24. The device according to claim 23, wherein the device loop includes a plate-shaped member having an opening defined therein for receiving the vehicle upper latching mechanism of the vehicle.

25.-26. (canceled)

27. The device according to claim 1, wherein the longitudinal axis of the elongated member substantially extends in a plane of the device loop; and wherein the longitudinal axis of the elongated member intersects at the second angle a plane of the device latching mechanism.

28. The device according to claim 27, wherein the device loop is fixed to the elongated member, and wherein the plane of the device loop intersects at an angle the plane of the device latching mechanism.

29.-32. (canceled)
